(19) United States
(12) Patent Application Publication
(10) Pub. No.: US 2018/0364069 A1
(43) Pub. Date: Dec. 20, 2018

(54) Electro-mechanical Trim Sensor for Marine Applications

(71) Applicant: Edward D. Penfield, Concord, MA (US)

(72) Inventor: Edward D. Penfield, Concord, MA (US)

(21) Appl. No.: 15/622,085

(22) Filed: Jun. 14, 2017

(51) Int. Cl. G01D 5/165

(52) U.S. Cl. CPC G01D 5/165; B63H 21/30

(57) ABSTRACT

This invention is for an actuator position sensing system that combines electronic and mechanical features in such a manner that are conducive to marine applications where the actuator and the sensing device are subject to submersion in water. Separating the mechanical and electronic aspects of the device into two sub-components, one being purely mechanical and the other being a converter of mechanical movement to electronic signals, the system allows for the purely mechanical portion to be attached to the actuator that operates under water, while the electronic portion remains in a relatively dry environment, usually within the confines of a vessel. The target application for the invention is for the trim/tilt position indication and trim limiting function of the outdrive unit of a vessel propulsion system known as an inboard/outboard motor.

### BACKGROUND OF THE INVENTION

### 1) Field of the Invention

The invention relates to a position monitoring system and movement limiting function, utilizing the linear position sensing of an actuator apparatus used to control the angular trim position of a marine propulsion device.

### 2) Description of Related Art

A powered marine vessel, having what is known as an inboard/outboard engine, utilizes a propulsion unit, commonly known to those experienced in the art as an outdrive 1. The outdrive propulsion unit 1 is attached to the transom 14 of a marine vessel using a transom assembly 2 that contains a gimbal assembly 3, which allows movement around the vertical axis 21 for steering and around the horizontal axis 20 for trim control, as shown in FIG. 1. Trim control is used to adjust the vessel's attitude as it is propelled over the water. Hydraulic actuators 4 are used to adjust the angular position of the outdrive 1 that affects trim control. The operator of the vessel needs to know the current position of the outdrive 1 and the amount of change that occurs when making any adjustments. The angular position of the outdrive 1 is displayed at the helm for easy viewing using gauges or other indicators. Additionally, safeguards are incorporated into the actuator control system that prevent angular tilting of the outdrive 1 beyond the limits of safe operation. Extreme positions of trim in an upward direction are referred to as tilt, as shown by the upward angle of the propeller axis of rotation 16 in FIG. 2C, where the outdrive 1 is tilted upward to a point where it can no longer be safely operated as a propulsion device. Tilt positions are commonly used when the vessel is anchored in shallow water or is being transported on a trailer, as the outdrive 1 is tilted upward to a point where it has minimal protrusion from below the level of the keel of the vessel.

A hydraulic powered actuator 4 with an actuator rod 5 extending from the actuator body is used on both sides of the outdrive 1 in a symmetrical manner to control the angular position of the outdrive 1 relative to its horizontal axis 20, as governed by the gimbal assembly 3, and shown in FIGS. 2A, 2B, 2C and 26. Angular movement of the outdrive 1 about the horizontal axis 20 is independent of the angular movement about the vertical axis 21. The body of the actuator 4 is attached to the lower portion of the gimbal assembly 3, creating a fixed position 6 relative to the horizontal axis 20, and the actuator rod 5 is attached to an outward and lower endpoint 7 of the outdrive 1 that is slightly above the ventilation plate 8, which isolates the propeller 26 and its propulsion area from the rest of the outdrive 1.

The hydraulic actuators 4 impart angular movement around the operationally horizontal axis 20 of the outdrive 1 by extending and retracting the actuator rods 5. The hydraulic systems of the actuators 4 on either side of the outdrive 1 are connected so that they move in like fashion and balance the load evenly between them. Full extension 9 of the actuator rods 5 tilts the outdrive 1 to its full upward position, which is suitable for transporting the vessel, as shown in FIG. 2C. The shaded portion of the actuator rod 5 denotes the amount of extension of the actuator rod, as does the arrow with reference 9, showing the full extension distance. Full retraction 11 of the actuator rods 5 lower the outdrive 1 to its full downward position, which is a slight downward angle as can be seen by the propeller axis of rotation 16 in FIG. 2A in comparison to the water line 15. Propulsion of the outdrive 1 in the full down position 11 provides a slight downward direction of thrust and creates lift for the stern of the vessel 14. Movement of the outdrive 1 to intermediate positions of trim provides neutral and slight upward directions of thrust (FIG. 2B). FIGS. 2A, 2B and 2C show the outdrive in the three significant positions as it pertains to the related art and the invention. FIG. 2A is the outdrive 1 in the full down position 11 as denoted by the actuator rod 5 fully retracted. FIG. 2B is the outdrive 1 in the trim limit position 17, which is the limit of trim where the outdrive 1 can be safely operated as a propulsion device, and as denoted by the actuator rod 5 extended to the trim limit 17. FIG. 2C is the outdrive 1 in the full tilt position 9 as denoted by the actuator rod 5 fully extended.

The trim position of the outdrive 1 is controlled by the operator of the vessel using a dual position momentary contact switch, known as the trim switch 23 located at the helm, usually mounted on or near the throttle lever, which powers the hydraulic system 24 of the actuators 4 in either direction as shown in FIGS. 28A and 28B. A functional schematic of a typical trim limiting system is shown in FIG. 5. The hydraulic system 24 that powers the actuators 4 utilizes a limit switching function 25 based on the angular position of the outdrive 1 to prevent the operator from raising the outdrive 1 beyond the safe operating trim position 17 using the helm switch 23. When the outdrive 1 reaches the defined limit to its safe trim angle, as defined by the extension of the actuator rod 5 to the trim limit 17, which is also denoted by the shaded portion of the actuator rod 5 in FIG. 2B, the limit switch 25 becomes open and the trim switch 23 will no longer raise the outdrive 1. The trim switch 23 will always lower the outdrive 1 regardless of its position, as the circuit to lower the outdrive 125 has no limit switching function. In order to raise the outdrive 1 beyond its trim limit 17, a secondary switch at the helm, known as the trailer switch 97, is used and by-passes the limit switch, utilizing direct wiring 99, and provides power to the hydraulic system 24 to raise the outdrive 1 beyond the trim limit 17.

Monitoring, adjusting and limiting the movement of the outdrive 1 requires that sensors be attached to the outdrive 1 to provide position information to the operator of the vessel and to the hydraulic system 24 that powers the actuators 4. A sensor can detect angular movement of the outdrive 1 by measuring the amount of displacement that occurs from a defined reference point at a certain distance radially outward from the axis of rotation. The further away from the axis of rotation that the displacement is measured, the greater the displacement will be for a given amount of angular rotation. Measuring displacement over a greater distance for a given amount of angular rotation as a means of position and movement sensing yields greater accuracy. Ideally, the sensing system should be placed as far away from the axis of rotation as practical. The amount of angular rotation imparted to the outdrive 1 is typically about 45 degrees for outdrive 1 trim/tilt systems driven by hydraulic actuators. An actuator rod 5 movement of about 200 mm is required to cause this amount of angular rotation. The actuators 4 happen to be positioned at the farthest practical point away from the horizontal axis of rotation 20 of the outdrive 1 to have substantial mechanical leverage for raising the outdrive 1 while not interfering with the hydrodynamics of the outdrive's propeller 26 and related streamlined surfaces, known to those experienced in the art as the lower unit 27. Therefore, the most effective and practical point to measure the displacement that results from the angular rotation of the outdrive 1 is also at the actuator 4, given its purposefully substantial distance from the horizontal axis of rotation 20.

Prior art systems measure the angular position and movement of the outdrive 1 using a rotational potentiometer, or a similar device, which are collectively known as a trim sender 95, and a rotational trim limit switch 96 positioned at the horizontal axis of rotation 20 of the outdrive 1 as shown in FIGS. 3 and 4. Due to the fact that the prior art senders are positioned at the axis of rotation and are of a practical size, the approximate 200 mm of travel, or full extension 9, of the actuator rod 5 is mechanically reduced to approximately 12 mm of travel 93 within the rotational trim sender 95 and the rotational trim limit switch 96, or a 16:1 reduction of movement, as shown in FIG. 3. Slight movements of the actuator rod 5 are not consistently detectable by the rotational potentiometer element 92, using this amount of mechanical reduction, due to tolerances in the mechanical linkages connecting the actuator rod 5 to the potentiometer element 92 within the trim sender 95.

Alternative systems of a prior art also include purely mechanical systems where the outdrive 1 actuator 4 uses a plunger and control cable apparatus to operate a mechanical linear display at the helm of the vessel. Practical space limitations at the helm station do not allow the display to be sized according to the full range of movement of the actuator rod 5. As a result, these systems are configured to only display the outdrive position in the lower half of the overall operating range. Secondary sensors and displays are still needed with these types of systems to provide monitoring of the outdrive movement in the upper half of the trim/tilt range, as well as provide a trim limiting function 25.

The invention provides a system for sensing the position and angular movement of the outdrive 1 that has both accuracy and reliability advantages over prior art systems of both a mechanical and electrical nature. These prior art systems have the following disadvantages:
1) Water related failures due to submersion of the electrical portions of the system in water.
2) A lack of accuracy due to mechanical reduction of the actuator's actual movement for the purpose of electronic sensing and the use of rotational potentiometers or similar rotational sensing elements.
3) Inaccuracy and reliability problems due to wear of the rotational potentiometer contact surface.
4) Separate devices are used for position sensing and limit control of the actuator.
5) Purely mechanical sensing systems with a directly connected display, while having good accuracy, are limited to actuator movements of approximately 100 mm or less due to practical space restrictions at the helm station, and therefore are not configured to display the position of the outdrive throughout its full range of movement.

Recent applications of magnetostrictive position sensing technology to a marine actuator as described in U.S. Pat. No. 8,997,628 address the inaccuracy of prior art systems, but have the disadvantage of underwater operation of electronic components, and additionally require magnetic properties to exist within the actuator unit that is being monitored.

The invention described herein achieves its accuracy by avoiding mechanical reduction of the actuator movement for the purpose of electronic sensing and achieves its reliability from above water operation and contactless operation of the electronic sensing components. The invention also combines the functions of position sensing and limit switching into a single device and readily connects to the wiring of prior art systems.

### BRIEF SUMMARY OF THE INVENTION

The invention consists of two major components. First, a combined position sensing assembly comprised of a mechanical position sensor, a control cable assembly, and an electronic linear sensor. Secondly, an electronic interface module which provides multiple types of electrical output and allows for adjustment of those outputs. The mechanical position sensor attaches to the actuator and actuator rod of the outdrive of an inboard/outboard powered vessel and transfers the full movement of the actuator rod by way of the control cable assembly to the electronic linear sensor.

The electronic linear sensor contains a magnetically operated potentiometer and a module containing an array of reed switches. The end of the control cable that resides in the electronic linear sensor is attached to a wiper device that contains a magnet of sufficient strength to operate the magnetic potentiometer and the reed switches. Movement of the actuator rod, which controls the angular position of the outdrive, is transferred by the plunger of the mechanical position sensor and the control cable assembly to the potentiometer's wiper device on a one-for-one basis, giving it accuracy advantages over prior art sensors. The potentiometer within the electronic linear sensor varies its resistance over the full range of travel of the actuator rod, which is approximately 200 mm for an outdrive.

The invention uses no mechanical reduction and the slightest movement of the actuator rod results in a corresponding movement of the wiper device of the potentiometer and a detectable change in its resistance.

Prior art trim senders generally have a resistance range of about 10-170 ohms. The magnetic potentiometer of the invention has a higher resistance range than the prior art rotational trim sender that it replaces to provide accuracy and adjustability to the system. The electronic interface module compensates for the different resistance range by using the current amplification properties of a power transistor circuit and provides adjustment of the electronics to achieve the desired helm display readings. Additionally, within the electronics interface module there is a higher impedance connection that is suitable for analog to digital signal conversion devices to interface with digital displays and vessel controller network systems, also known as National Marine Electronic Association (NMEA) 2000 networks.

The electronic linear sensor also includes a reed switch array module that provides a trim limiting function, replacing the prior art trim limit switch, so that the single position sensing assembly performs both the position sensing function and the trim limiting function accomplished by the two separate prior art sensors.

The wiring and connectors of the electronic interface module and of the electronic linear sensor are compatible with the wiring and connectors within a vessel, so that the invention can be easily connected to existing wiring and gauges of a vessel as original equipment or in a field retrofit fashion.

The embodiment of this invention utilizes the benefit of the following patent: U.S. Pat. No. 8,138,860 “Magnetically-activated Membrane Potentiometer”, assigned to Spectra Symbol Corp.

### BRIEF DESCRIPTION OF DRAWINGS

FIG. 1 shows a perspective view of an outdrive unit of an inboard/outboard marine engine, its horizontal and vertical axis of angular movement, and one of the two actuators used to control the outdrive position relative to the horizontal axis of movement.

FIG. 2A is a side view of an outdrive, showing it in the full down position, where the transom assembly is shown with a cut-away area around the horizontal axis of rotation to reveal the prior art trim sender.

FIG. 2B is a side view of an outdrive, similar to FIG. 2A, showing the trim limit position of the outdrive and the related extension of the actuator rod to the trim limit position, which is shown by the shaded area of the actuator rod and the associated arrow.

FIG. 2C is a side view of an outdrive, similar to FIG. 2B, showing the outdrive in the full tilt position and full extension of the actuator rod, which is shown by the shaded area of the actuator rod and the associated arrow.

FIG. 3 is a magnified view of the prior art trim sender, with a cut-away view of the sender case, revealing the internal rotational potentiometer element that resides within the trim sender, to show the related mechanical reduction of movement, where approximately 200 mm of travel by the actuator rod results in about 12 mm of movement of the rotational potentiometer element, an approximate 16:1 reduction of movement.

FIG. 4 is a prior art trim limit switch mounted at the horizontal axis of rotation of the outdrive, and typically mounted on the opposite side of the trim sender, used to prevent angular tilting beyond the safe operating limit of the outdrive.

FIG. 5 shows a functional schematic of the trim limit switch and the relationship of the helm trim switch and what is commonly known as the trailer switch, which overrides the trim switch.

FIG. 6 is a perspective view of the position sensing assembly, which is comprised of the mechanical position sensor, the control cable, and the electronic linear sensor.

FIG. 7 is a sectional view of the mechanical position sensor and its related fastener elements.

FIG. 8 is a view of the control cable assembly with its associated elements, where the cable is shown in a broken segment view for ease of display, and the wiper device is shown with hidden lines to indicate the internal elements.

FIG. 9A shows an alternate embodiment of the mechanical position sensor as an integral part of the actuator.

FIG. 9B shows an alternate embodiment of the plunger as an integral part of the control cable.

FIG. 10 is a sectional view of the of the electronic linear sensor elongate housing.

FIG. 11 is a perspective view of the special eye bolt, showing the detail with a large flat washer as the eye to fasten it to the actuator rod endpoint.

FIG. 12A is a perspective view of the electronic linear sensor elongate housing.

FIG. 12B is a perspective view of the electronic linear sensor elongate housing with a cut-away section to reveal the internal elements.

FIG. 13A is a perspective view of the reed switch module.

FIG. 13B is another perspective view of the reed switch module with a cut-away section to reveal the circuit board assembly housed within the module, and the reed switches, being on the opposite side of the circuit board in this view, are shown using hidden lines.

FIG. 14 is a sectional view of the reed switch module.

FIG. 15 is another sectional view of the reed switch module where the view is 90-degrees rotated from the view of FIG. 14.

FIG. 16 is a perspective view of the circuit board and reed switches that are housed within the reed switch module.

FIG. 17 is the electrical schematic for the reed switch module.

FIG. 18 is a perspective view showing the attachment of the reed switch module to the electronic linear sensor elongate housing.

FIG. 19 is a sectional view of the electronic linear sensor's elongate housing and the reed switch module combined as the electronic linear sensor assembly.

FIG. 20 is another sectional view of the electronic linear sensor elongate housing and reed switch module, where the view is 90-degrees rotated from FIG. 19.

FIG. 21 is a perspective view of the position sensing assembly, similar to FIG. 6, with the addition of cut-away sections in the mechanical position sensor and the electronic linear sensor to reveal the one-for-one transfer of motion from the plunger to the wiper device.

FIG. 22 is a sectional view of the combined position sensing assembly with special cut-away sections at the two hardware fastener points that reveal how the cable assembly fastens to the mechanical position sensor and the electronic linear sensor.

FIG. 23A is a perspective view of the electronic interface module.

FIG. 23B is another perspective view of the electronic interface module showing the internal circuit board in hidden lines.

FIG. 24 is the electronic schematic for the electronic interface module.

FIG. 25 is a perspective view of the printed circuit board assembly for the electronic interface module.

FIG. 26 is a perspective view of the outdrive from a slight overhead angle to show the installation details of the mechanical position sensor.

FIG. 27A is a side view of an outdrive in the full down position, shown in phantom lines to emphasize the mechanical position sensor of the invention as it relates to the actuator and actuator rod that controls the angular position of the outdrive.

FIG. 27B is a side view of an outdrive in the full up position, shown in phantom lines to emphasize the mechanical position sensor of the invention as it relates to the actuator and actuator rod, and the corresponding extension of the plunger is shown by the shaded area.

FIG. 28 is a perspective view of the overall invention as it would be installed into a vessel with cut-away portions of the vessel to show the details of installation.

FIG. 28A is the enlarged partial view of FIG. 28 showing the details of installation of the invention in the stern (rear) portion of the vessel.

FIG. 28B is the enlarged partial view of FIG. 28 showing the details of installation of the invention in the more forward section of the vessel at the helm station.

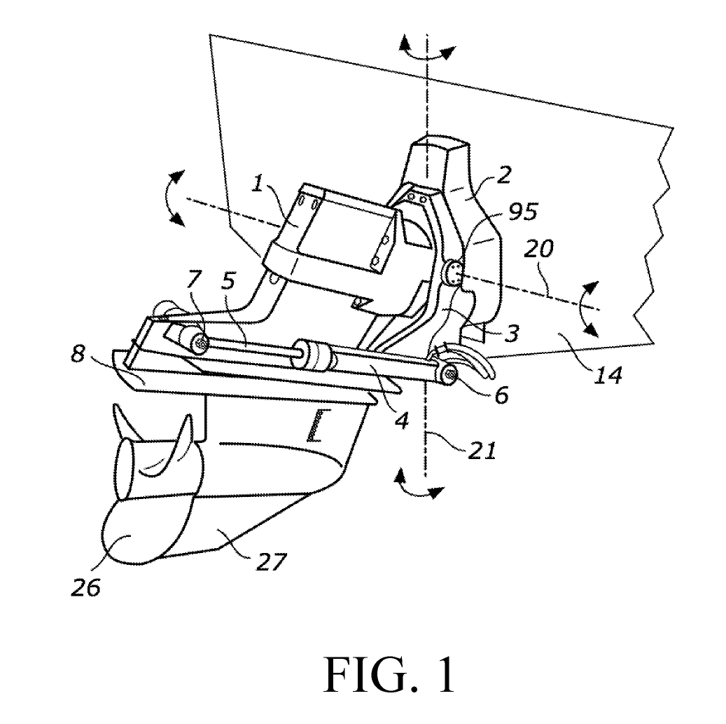

### EMBODIMENT OF THE INVENTION

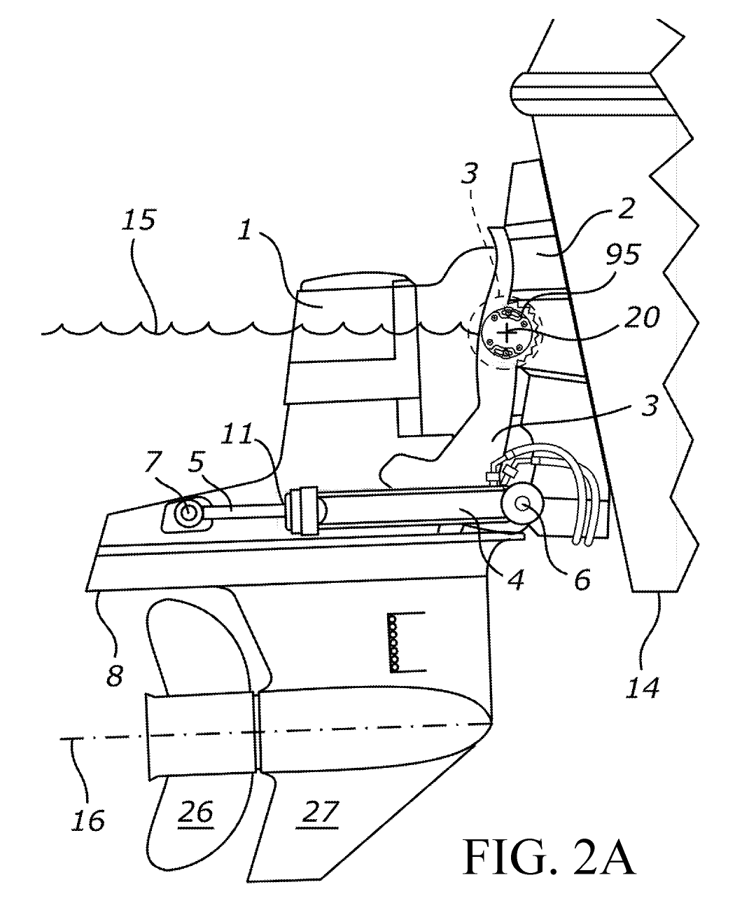

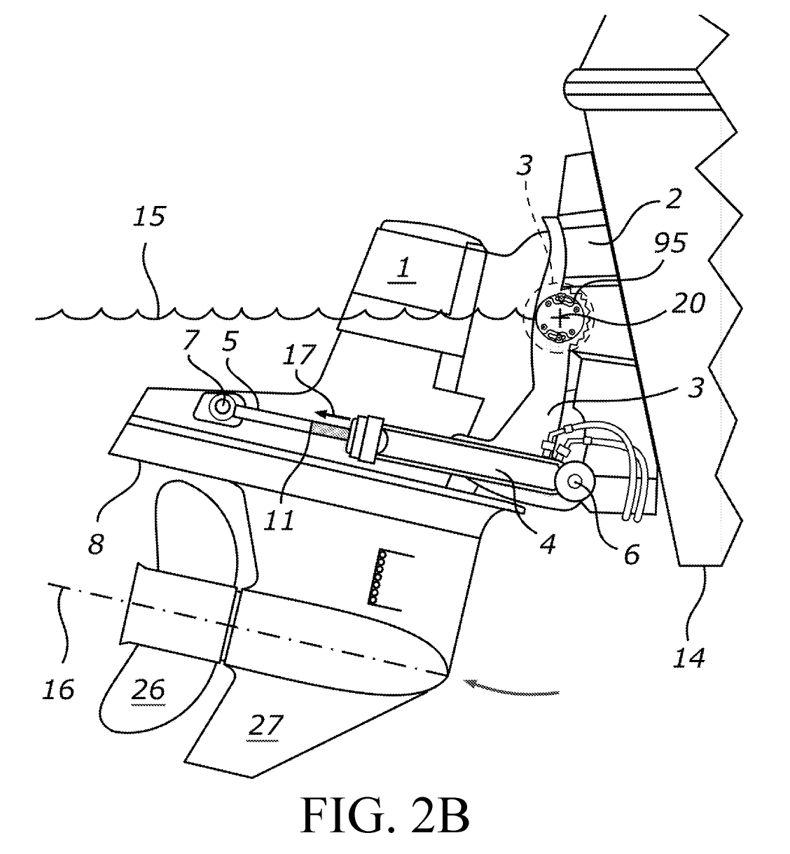

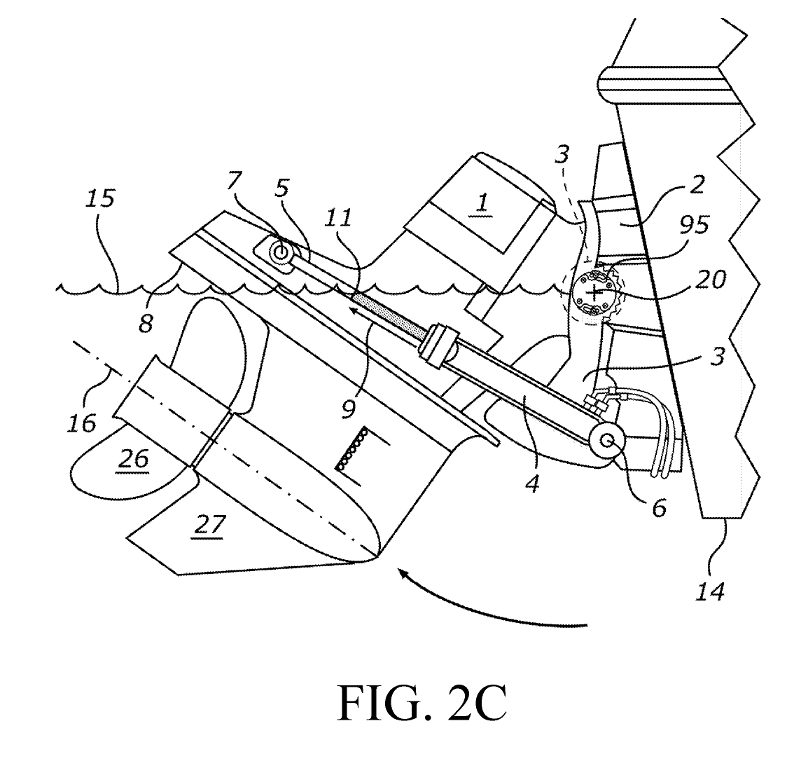

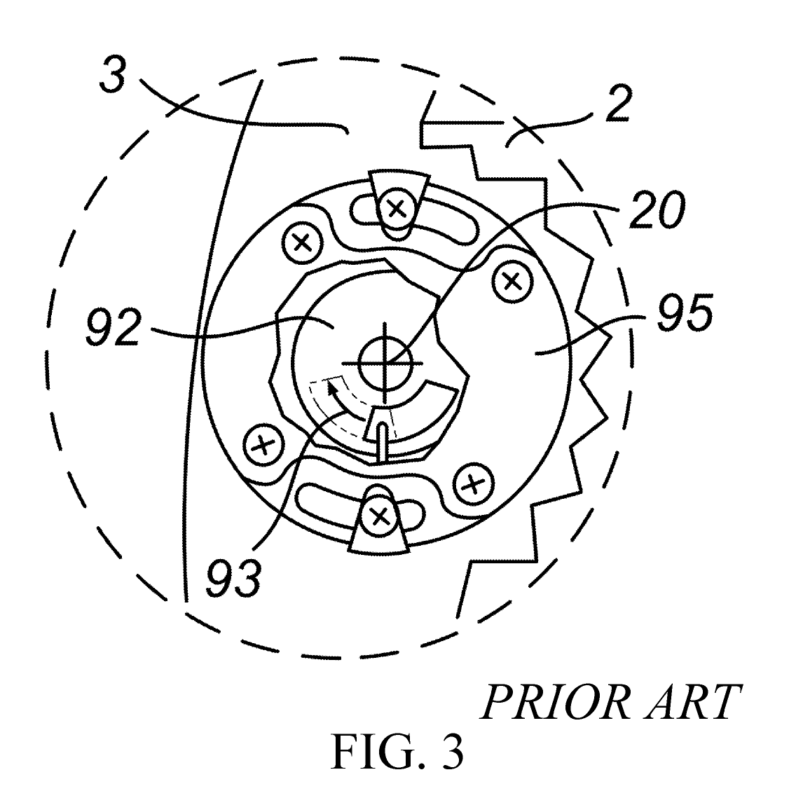

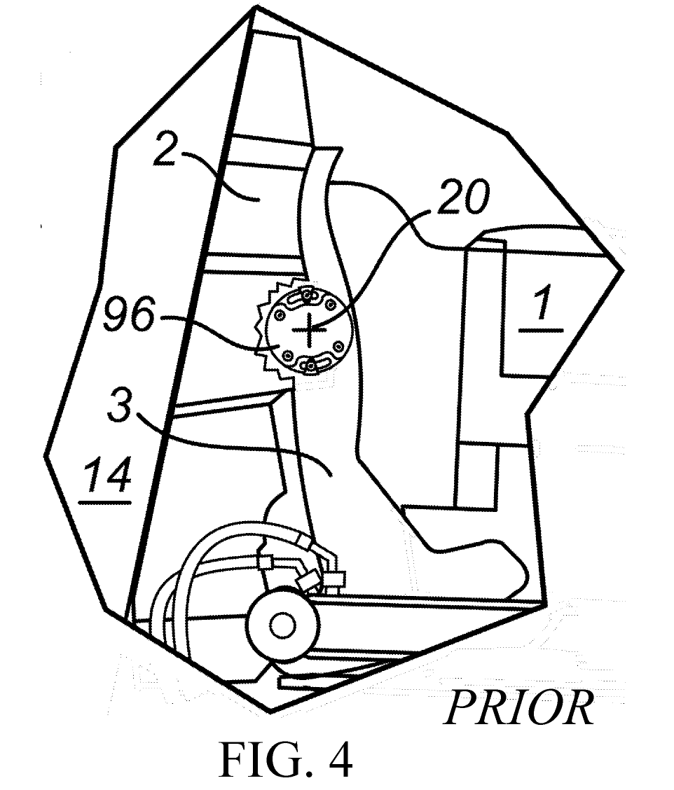

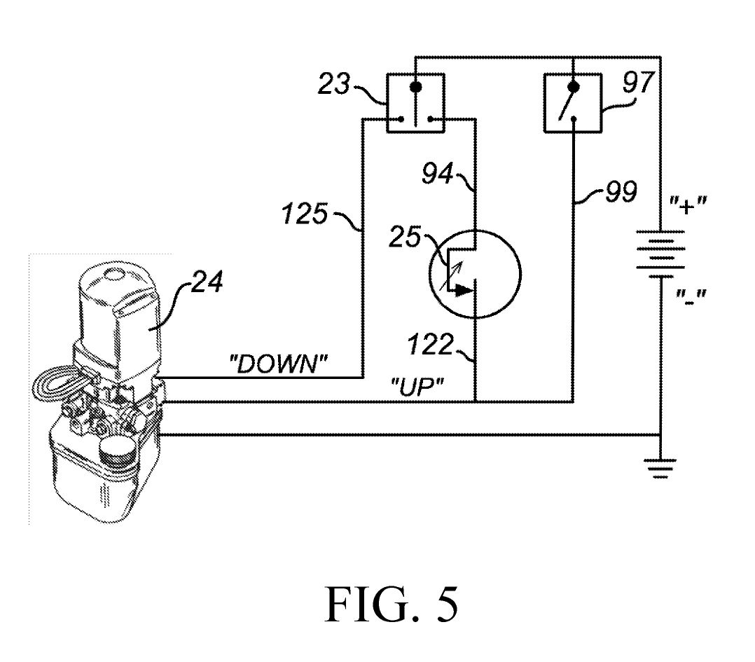

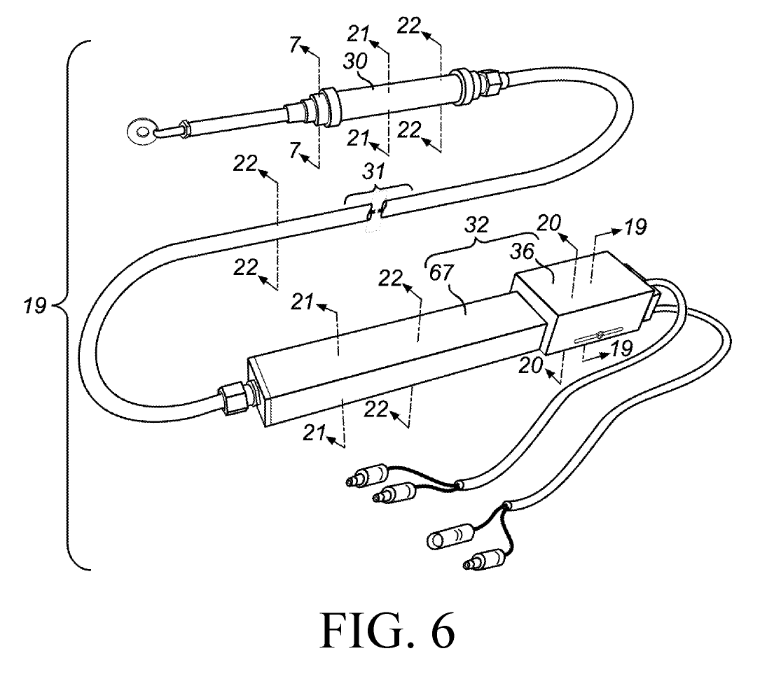

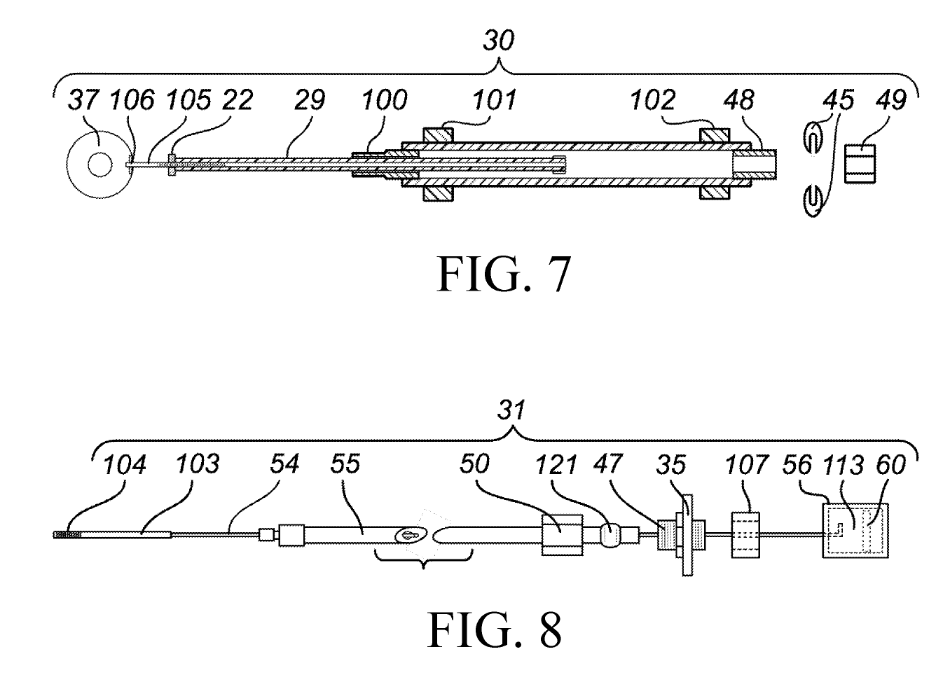

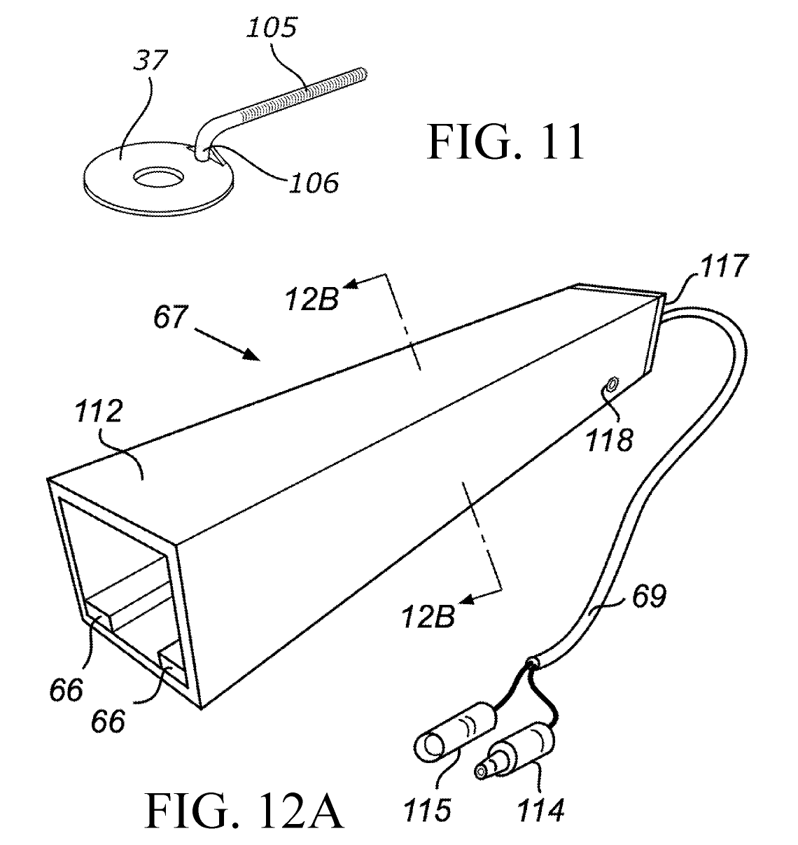

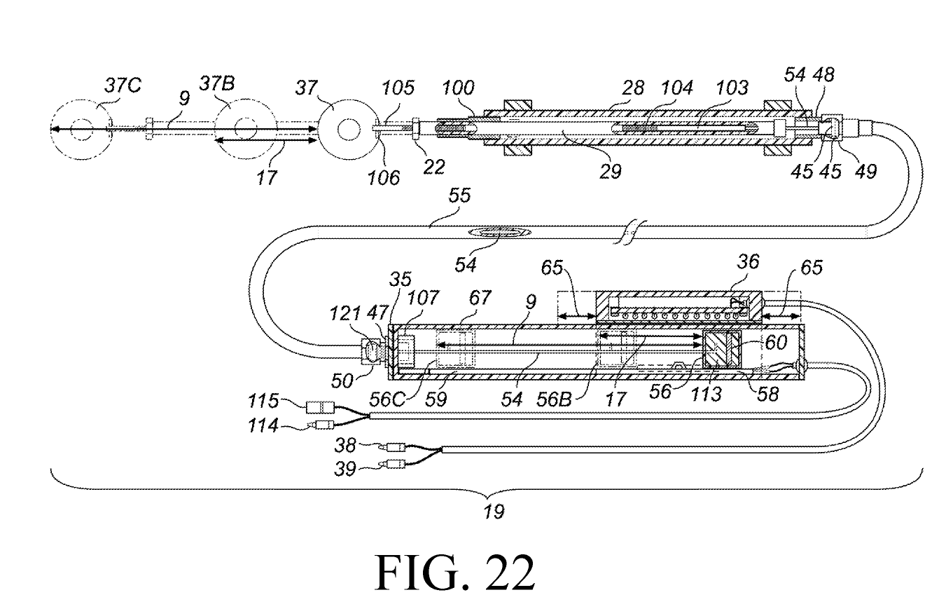

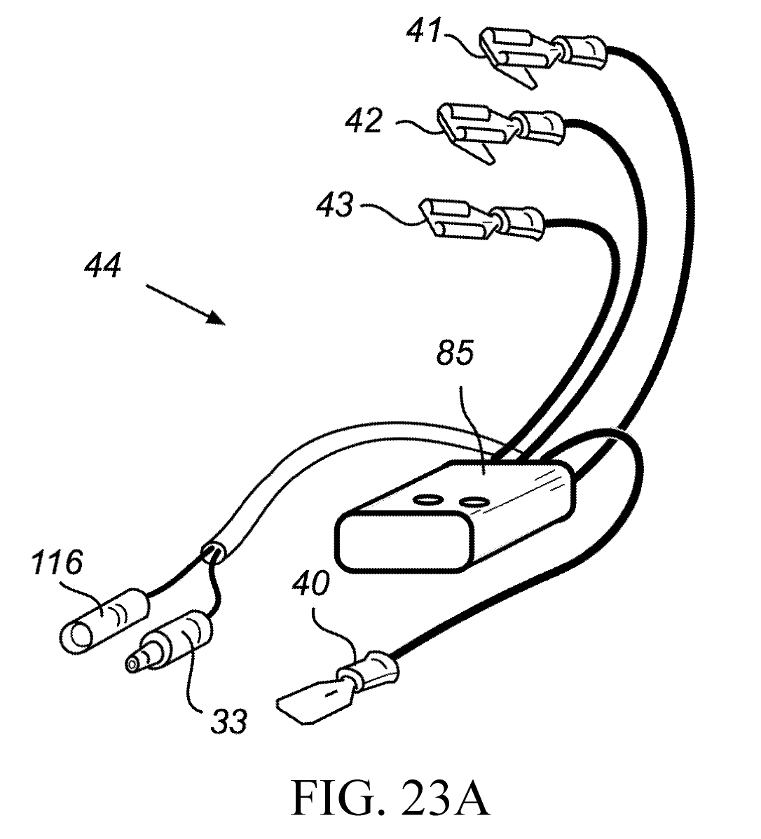

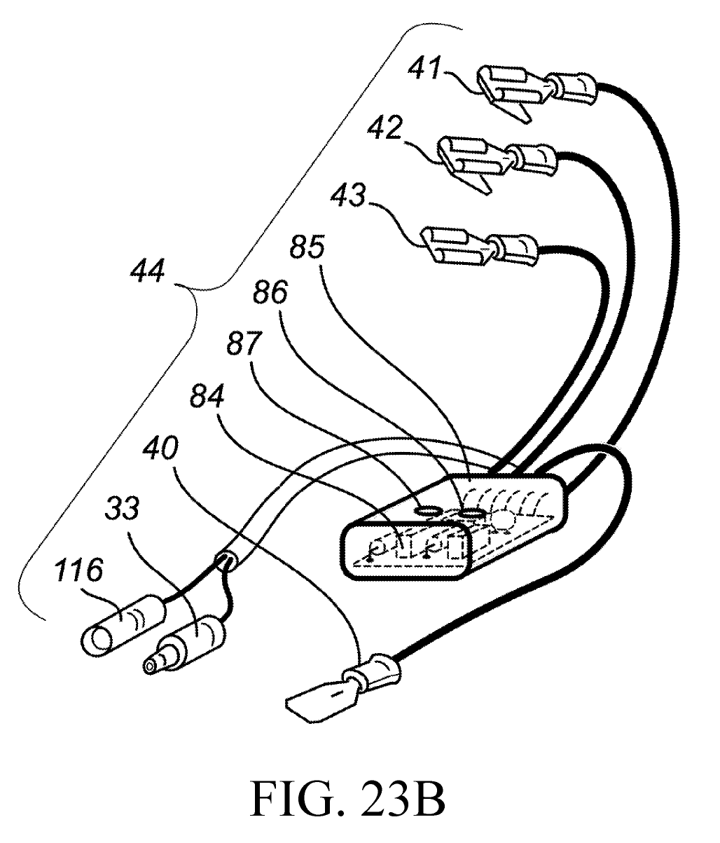

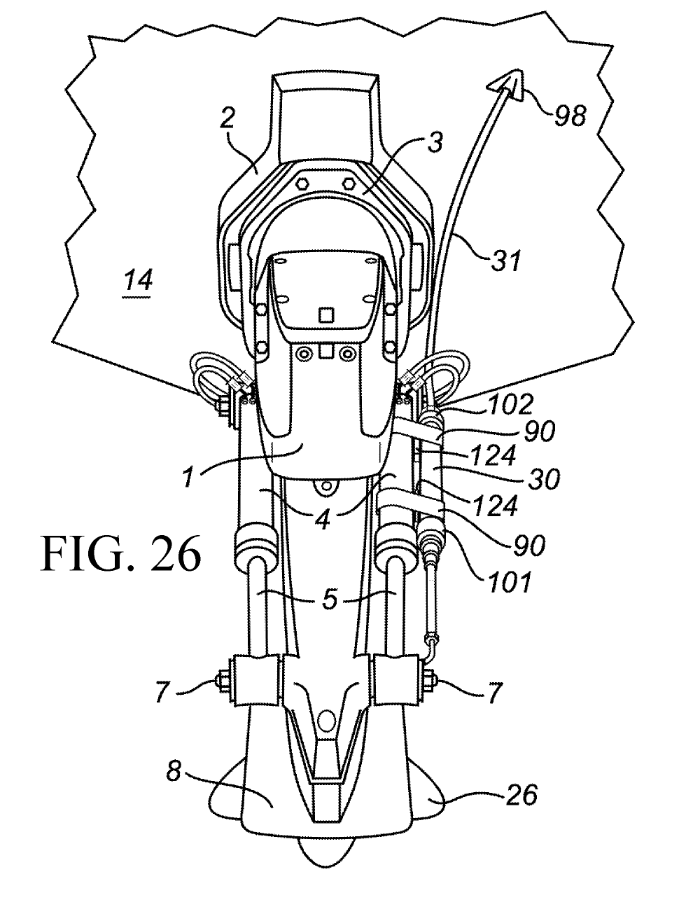

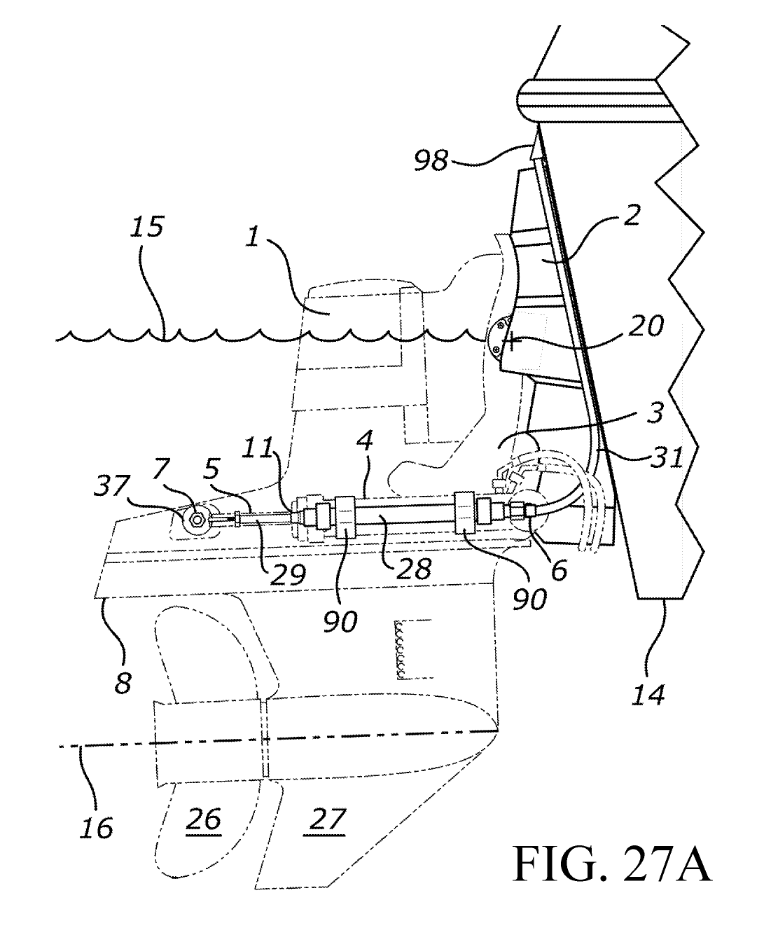

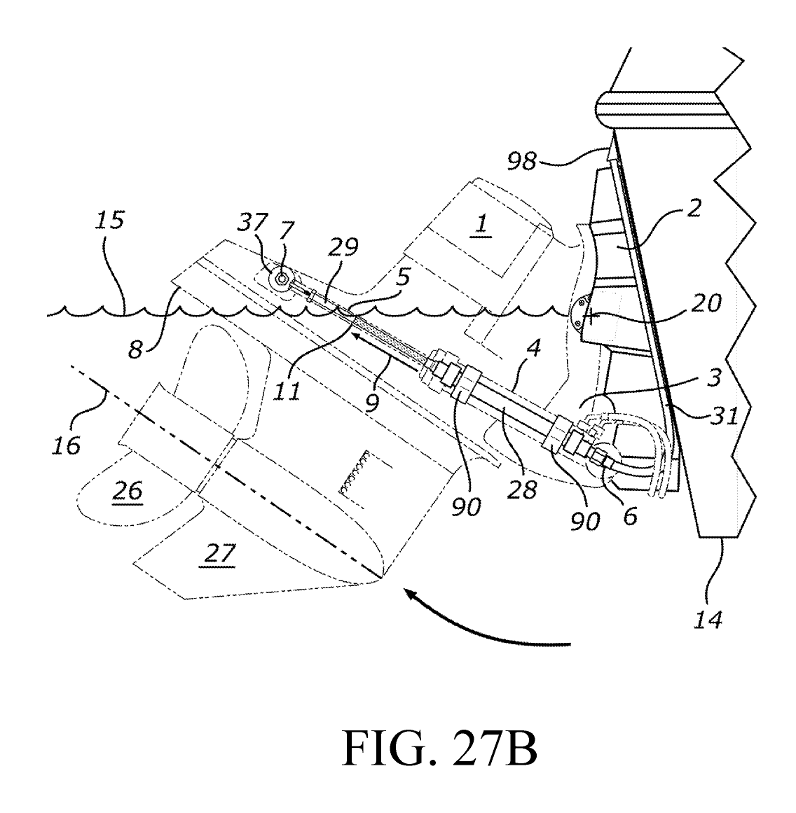

The invention consists of a combined assembly for position sensing 19, shown in FIGS. 6, 21, and 22, and an electrical interface module 44, shown in FIGS. 23A and 23B, for operating several types of displays. The outdrive 1 and the related actuators and position sensors are subject to underwater operation and much of the outdrive 1 remains under water 15 while the vessel is in the water at rest as shown in FIGS. 2A, 2B, 2C, 27A and 27B. The position sensing system 19 includes a mechanical position sensor 30, comprised of a cylindrical barrel 28 and a plunger 29, as shown in FIG. 7, that are impervious to water and attaches with metal band clamps 90 to the actuator 4 of the outdrive 1, as shown in FIGS. 26, 27A and 27B. The barrel 28 of the mechanical position sensor 30 is attached to the body of the actuator 4 and the plunger 29 of the mechanical position sensor 30 is attached to the endpoint 7 of the actuator rod 5 where the rod is attached to the outdrive 1, so that the actuator rod 5 and the plunger 29 have the same axis of movement and move in unison. Raised ribs 101 and 102 on the barrel 28 of the mechanical position sensor 30, as can be seen in FIGS. 7 and 26, provide positioning for the metal band clamps 90. The band clamps 90, along with two rubber shims 124 that are captive between the barrel 28 and the actuator 4, hold the barrel 28 firmly in place along the actuator 4, creating a fixed position of reference (FIG. 26). The plunger 29 has an offset eyebolt fastener/washer combination 37 fastened at its external end to provide hardware that is compatible with the attachment point 7 of the actuator rod 5. The offset eyebolt 37 is shown in FIG. 11. The specialized eyebolt 37 has a threaded bolt 105 with a right-angle bend that is attached to the perimeter of the flat washer 106 giving it a slight offset to accommodate the necessary installation alignment of the actuator rod 5 and the plunger 29, and is fastened into the plunger 29 and held secure by a locking nut 22, as shown in FIGS. 7 and 22. The attachment point 106 at the perimeter of the specialized eyebolt 37 has small stiffeners mating the threaded bolt 105 to the flat washer portion in order to reduce metal fatigue from any torque that is placed upon the attachment point. The threaded bolt 105 of the special eyebolt 37 allows for adjustment of the plunger 29 relative to the attachment point 7 of the actuator rod 5. Movement of the actuator rod 5 will cause an equal movement of the sensor plunger 29. The plunger guide bushing 100 within the barrel 28 provides stability to the plunger 29, insuring smooth extension and retraction.

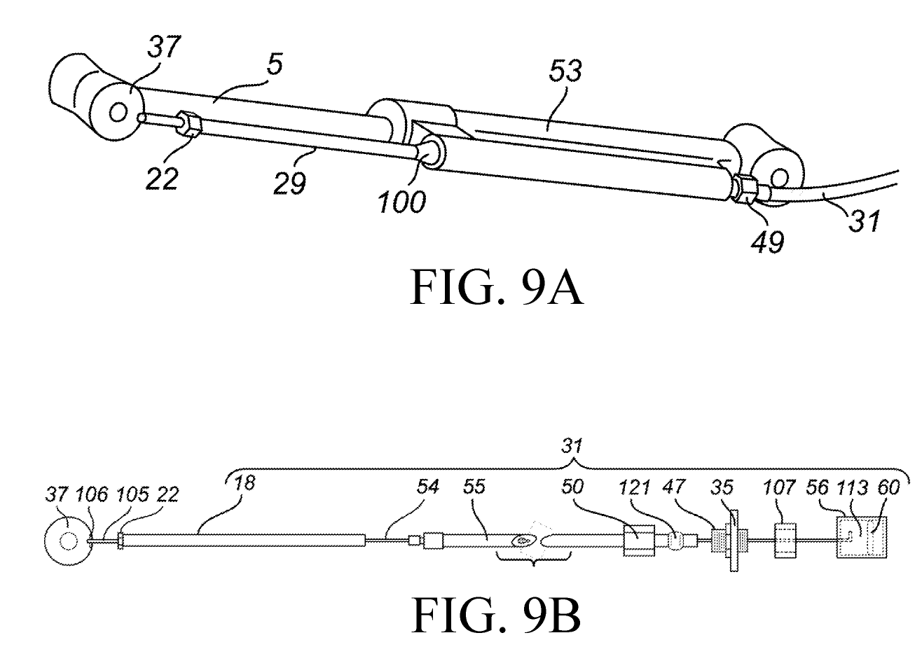

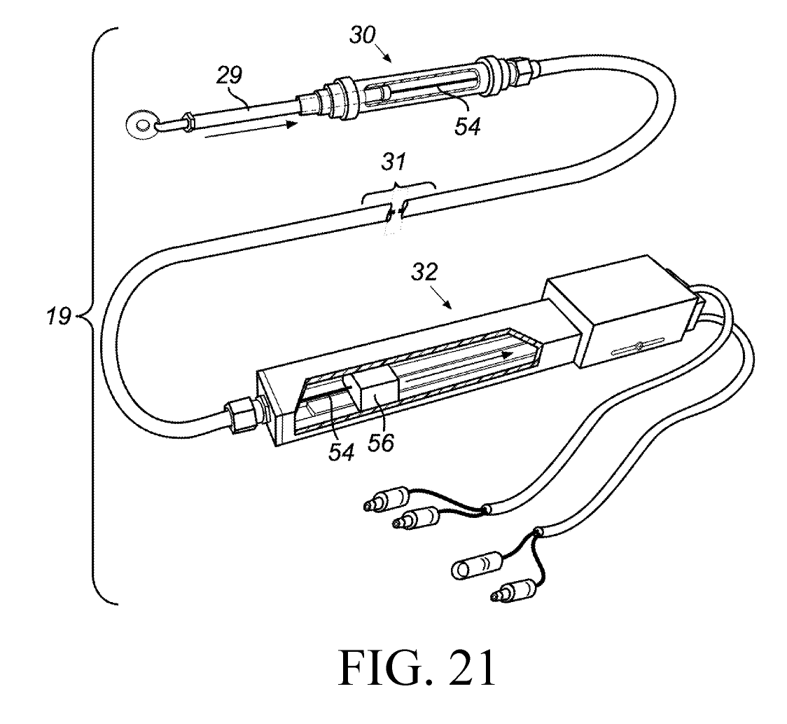

The mechanical position sensor 30 acts to transfer the actuator rod 5 movement to the electronic linear sensor 32 by way of a push/pull cable assembly 31 that is comprised of a control cable 54 and an outer jacket 55. The electronic linear sensor 32 converts the position of the actuator rod 5 to an electrical signal as shown in FIGS. 21 and 22. An alternative embodiment of the mechanical position sensor is to have the barrel 28 built into the actuator body as a single unit 53 shown in FIG. 9A. The plunger 29 of the mechanical position sensor 30 also has an alternate embodiment by being incorporated into the control cable 54 as a thicker and more rigid section of the cable 18, as shown in FIG. 9B. The alternate form of the plunger 18 is bored and threaded at its end to attach the special eyebolt 37 and its related elements 105 and 106, along with the locking nut 22. All other aspects of the invention work the same with either of the two embodiments.

The control cable assembly 31, having an inner control cable 54 and an outer jacket 55 that are suitable for under water operation, is used to transfer the actuator rod 5 movement by way of the plunger 29 to a wiper device 56 that is captive within the electronic linear sensor 32 (FIGS. 8, 21, and 22). The control cable 54 is connected to the end of the plunger 29 that is internal to the barrel 28 of the mechanical position sensor 30 by means of a rigid cable end 103 with a threaded end section 104, as shown in FIG. 22, and said cable passes through the open end of the position sensor barrel 28 at the threaded fitting 48 where the outer jacket 55 of the cable assembly 31 is fastened to the barrel end fitting 48 using two slotted washers 45 and an end nut 49, creating a fixed point of reference for the cable assembly 31. The control cable 54 within the outer jacket 55 is free to move in a push/pull manner as governed by the plunger 29 and as can be seen in FIG. 21. The other end of the control cable assembly 31 has the outer jacket 55 attached by way of a crimp sleeve 121 and an end nut 50 fastened to a threaded fitting 47 that is fastened to the receiving end cap 35 of the electronic linear sensor 32, as shown in FIGS. 8 and 22. The end of the control cable 54 that resides within the electronic linear sensor 32 has a right angle bend that is inserted into the wiper device 56 and held captive within the wiper device 56 by a cured resin-based plastic compound 113. The wiper device 56 also contains a magnet 60 and operationally resides in the electronic linear sensor 32 when the cable assembly 31 is mated to the electronic linear sensor 32. In practical application, the control cable assembly 31 is installed through the transom/stern area 14 of the vessel in a position that is reasonably higher than the water line 15 and secured at the point of entry to the vessel by a water sealing grommet 98 as shown in FIGS. 26, 27A, 27B, and 28A. Installation of the control cable assembly 31 through the transom area 14 of the vessel provides for the separation of the mechanical position sensor 30 and the electronic linear sensor 32 into two different environments, the mechanical position sensor 30 being in the wet environment and the electronic linear sensor 32 being in the relatively dry environment. The length of the control cable assembly 31 is sufficient to provide the described separation of the mechanical position sensor 30 and the electronic linear sensor 32, and in practice is about 2 meters long.

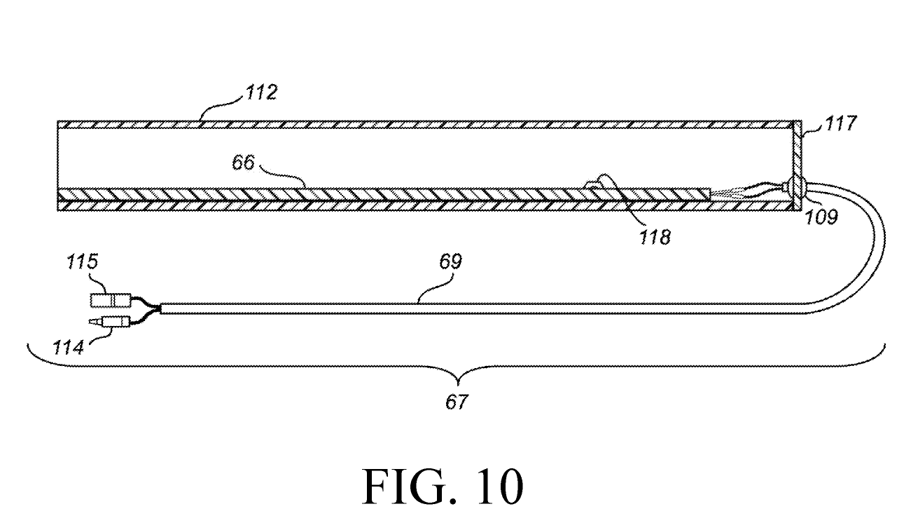

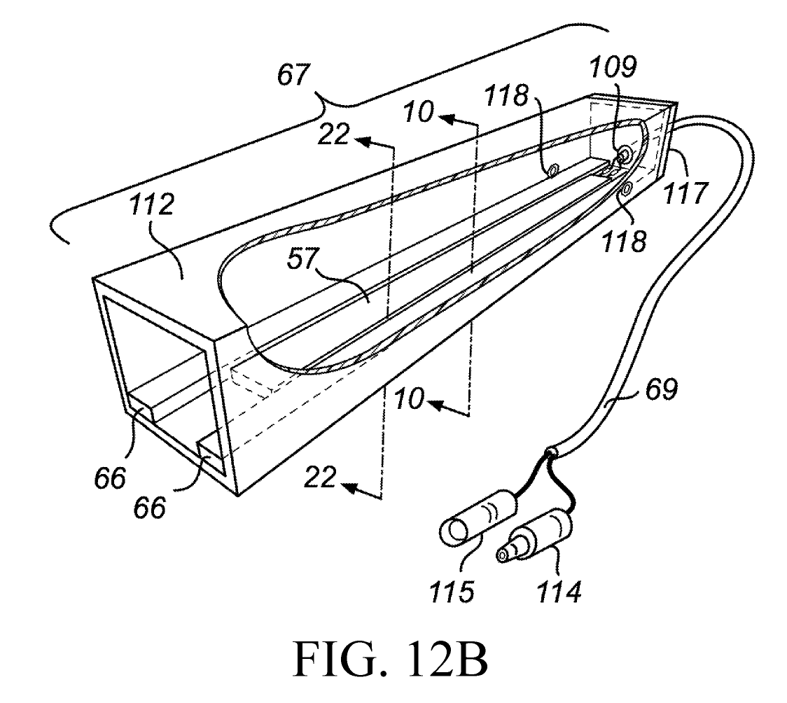

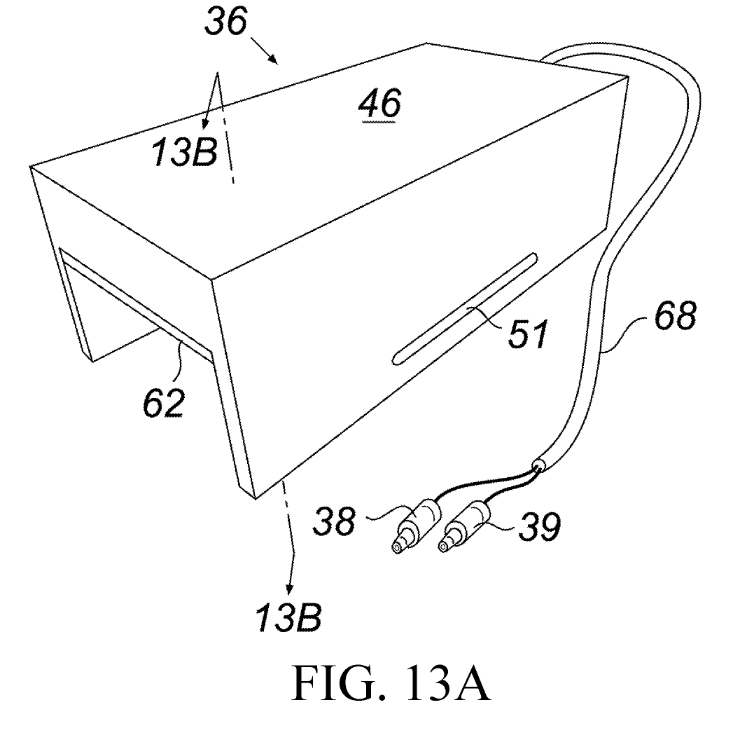

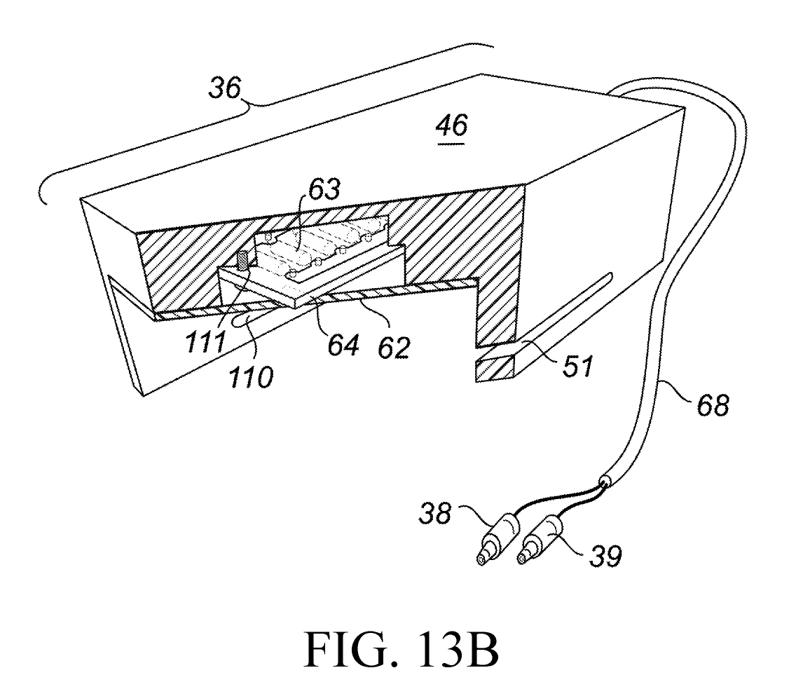

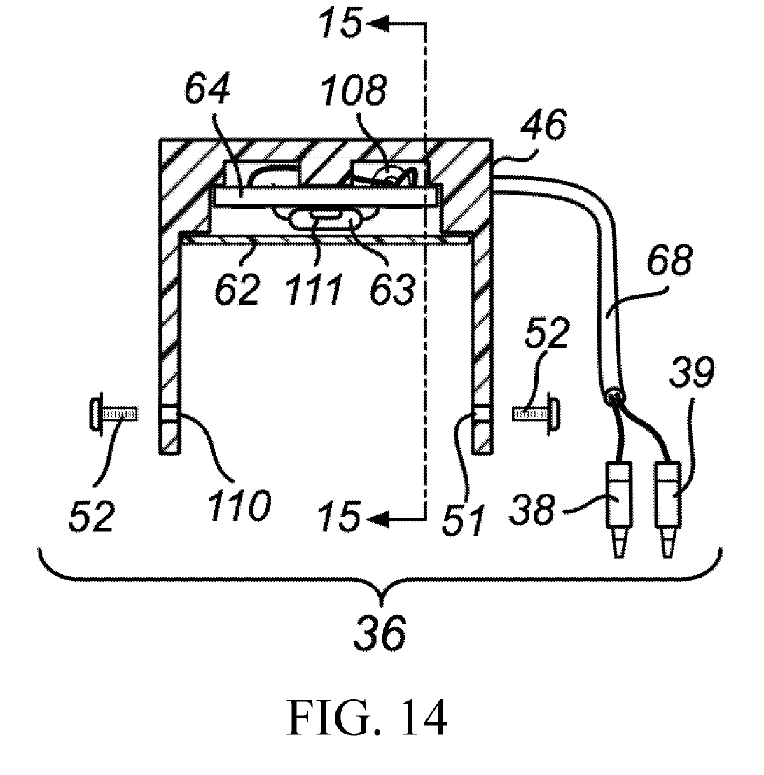

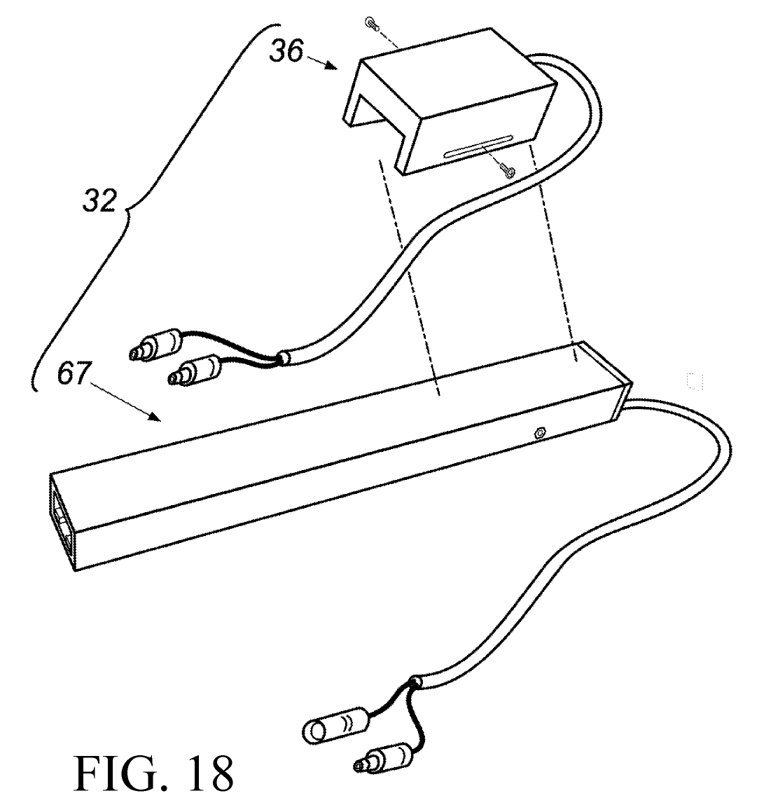

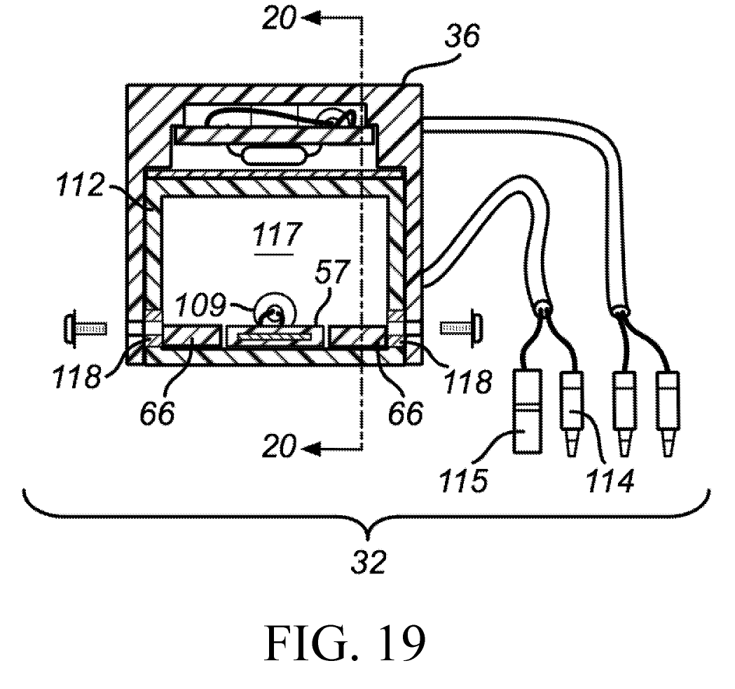

The electronic linear sensor 32, shown in FIGS. 6, 18, 21, and 22, is comprised of an elongate housing assembly 67 that contains a magnetically operated, physically linear potentiometer 57 with an operational length that is at least equal to the distance of full travel 9 of the actuator rod 5, as shown in FIG. 22. The electronic linear sensor 32 also has a module 36 attached that contains an array of reed switches 63, which are also magnetically operated. Details of the elongate housing assembly 67 are shown in FIGS. 10, 12A, and 12B. Details of the reed switch module 36 are shown in FIGS. 13A, 13B, 14, and 15. The assembly of the two elements, 67 and 36, is shown in FIG. 18, to become the electronic linear sensor 32.

When the three elements of the position sensing assembly 19, namely the mechanical position sensor 30, the control cable assembly 31, and the electronic linear sensor 32, are assembled together as shown in FIGS. 21 and 22, and the mechanical position sensor 30 is attached to the actuator 4 and actuator rod 5 in the prescribed fashion, as shown in FIG. 27A, the connections of the plunger 29, control cable 54 and wiper device 56 are such that the full down position 11 of the actuator rod 5 results in the wiper device being at the low resistance end 58 of the potentiometer 57. As the outdrive 1 is raised by the actuator rod 5, it causes an equal movement of the plunger 29 and the control cable 54, moving the wiper device 56 from the low resistance end 58 toward the high resistance end 59 of the potentiometer 57. Sizing of the electronic linear sensor 32 and its elements are such that the full tilt position 9 of the outdrive 1 coincides with the high resistance end 59 of the potentiometer 57. The wiper device 56 within the electronic linear sensor 32, containing the magnet 60, is embedded with the plastic compound 113 to prevent moisture related deterioration, as well as hold the end of the control cable 54 in place. The magnet 60 has ample field strength to operate the magnetic potentiometer 57 as well as the reed switches 63 contained within the reed switch module 36, and as such, the wiper device 56 and the magnet 60 are wider than the magnetic potentiometer 57. In order to provide stability to the wiper device 56 as it reciprocates within the elongate housing 67 of the electronic linear sensor 32, two slide rails 66 are positioned and secured on either side of the potentiometer 57, as shown in FIGS. 12A and 12B, so that the wiper device 56 has a wider surface upon which to slide back and forth with the movement of the actuator rod 5. The elongate housing 67 of the electronic linear sensor 32 is comprised of a rectangular channel 112 with embedded fastener nuts 118 on each side, the magnetic potentiometer 57, the two slide rails 66 on either side of the magnetic potentiometer 57, an end cap 117 with a grommet 109, and a duplex wire 69 with connectors 114 and 115 that connect to the electrical leads of the potentiometer 57.

The cable assembly 31 is configured with an internal stopper bushing 107 that resides within the elongate housing 67 of the electronic linear sensor 32 to provide a malleable stopping point for the wiper device 56 and avoid damage if there is a slight over extension of the plunger 29, causing a movement of the wiper device 56 beyond its intended limits (FIG. 22). A critical design aspect of the invention is that the full reciprocating distance of travel of the wiper device 56 and the active operating distance of the potentiometer 57 are equal to or slightly greater than the full distance of reciprocating travel 9 of the actuator rod 5. In order to achieve proper alignment of the invention with the workings of the actuator 4, the mechanical position sensor 30 is attached to the actuator 4 during the installation of the invention with the plunger 29 in the full retracted position, and the actuator rod 5 is in its fully retracted position 11, so that the full range of travel of the moving elements of the position sensor assembly 19 corresponds to that of the actuator rod 5.

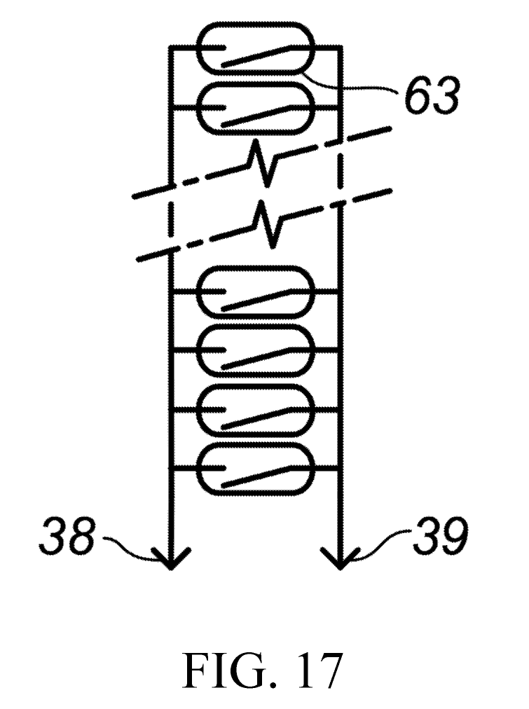

The electronic linear sensor 32, shown in FIGS. 6, 18, 21, and 22, has the reed switch module 36 attached, which contains an array of reed switches 63 that are mounted to a circuit board 64 and electrically connected in parallel (FIGS. 13A, 13B, 14, 15, 16, and 17). The reed switch module 36 attaches to the electronic linear sensor housing 67 in such a manner that the reed switches 63 are in close proximity to the magnetic wiper device 56 that is internal to the elongate housing assembly 67 of the electronic linear sensor 32, as shown in FIGS. 18 and 22. The reed switch module 36 has slotted holes 51 and 110 for adjustable mounting to the elongate housing assembly 67.

The reed switch module, in total, is comprised of the reed switches 63, the circuit board 64, the module housing 46, two fasteners 111 to mount the circuit board 64 to the module housing 46, and a cover plate 62 to seal the underside of the housing 46. The reed switches 63 are close together within the reed switch module 36 and the magnetic field of the wiper device 56 is strong enough so that while the wiper device 56 is within the boundaries of the reed switch module 36 at least one of the reed switches 63 will be activated. The range of movement of the wiper device 56 that causes at least one of the reed switches 63 to be activated is referred to as the activation range of the reed switch module 36. The reed switches 63 perform the function of a trim limiting switch 25 and the activation range is set to be equal to the trim range 17 of the outdrive 1 actuator rods 5. To this end, the reed switch module 36 is sized according to the trim range 17 and is attached to the end of the electronic linear sensor 32 that corresponds to the position of the wiper device 56 during movement of the actuator rod 5 while within the trim range 17 of the outdrive 1. The reed switch module 36, with its slotted mounting holes 51 and 110, is manually adjustable by re-positioning and re-fastening it using the screws 52 and the matching nuts 118 embedded into each side of the electronic linear sensor elongate housing 67. This feature allows for adjustment of the activation range of the reed switch module 36 to match the specified trim range 17 of the outdrive 1. Adjustment would be needed during the initial installation of the entire system to match the activation range of the reed switch module 36 to the trim limit 17, and infrequently thereafter. The reed switch module 36 is of sufficient length to provide activation during the trim range 17 of movement of the outdrive 1 as well as provide enough overlap for adjustment. Different models of outdrives have different trim limits. Trim activation ranges of various outdrive models are typically between 60 mm and 90 mm of actuator rod 5 movement from the full down position 11. The adjustment range 65 of the reed switch module 36 accommodates a greater activation range of 50 mm to 100 mm to ensure that it can accommodate the variety of outdrive models and still provide an additional amount for installation variances.

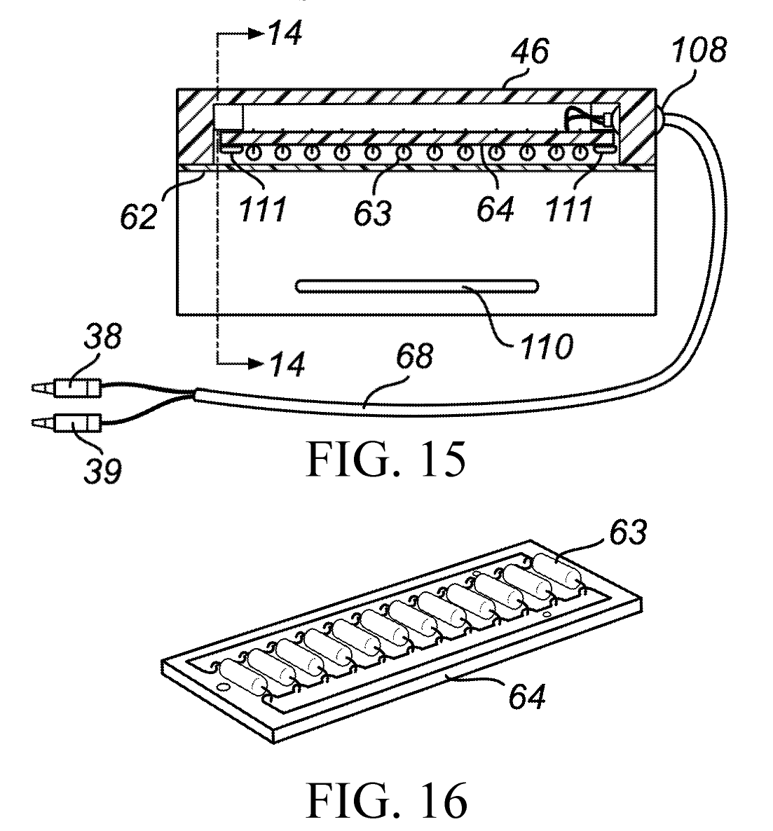

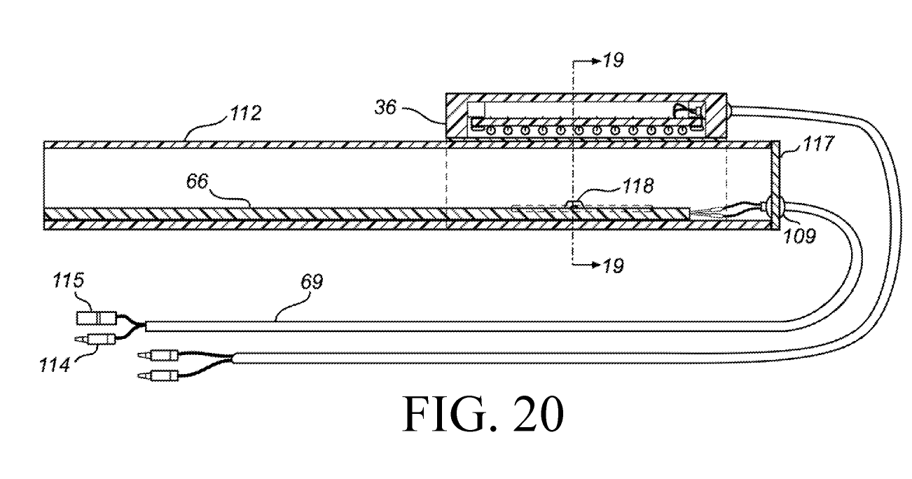

The electrical connectivity of the reed switch module 36 to the trim limit wiring 94 and 122 within the vessel is achieved by a duplex electrical wire 68 that connects to each side of the reed switch circuit board 64 and leads externally from the module 36. The duplex wire 68 has connectors 38 and 39 at the external end that are compatible with vessel trim limit connectors 119 and 120 and utilize the vessel wiring for the hydraulic system 94 and 122. The duplex wire 69, which leads externally from the elongate housing 67, has connectors 114 and 115 at the external end that are compatible with the vessel trim sender wiring 61 and 91 by way of the connectors 70 and 72. The duplex wires 68 and 69 that lead from the electronic linear sensor 32 are secured at the exit of the body their respective modules 36 and 67 by the grommets 108 and 109, as shown in FIGS. 15 and 20, to seal out moisture. The electronic components 57 and 63 of the electronic linear sensor 32 are also sealed so that they are impervious to moisture and comply with marine electrical standards for spark suppression, known as SAE J1171, making the electronic linear sensor 32 suitable for mounting within the engine compartment of an inboard/outboard motor.

The position sensing assembly 19, as shown in FIGS, 6, 21, and 22, provides the function of transforming mechanical movement of the actuator rod 5 into an electrical signal. The electronic output signal of the position sensing assembly 19 is analog in nature and varies throughout the range of movement of the plunger 29, control cable 54, and wiper device 56. FIG. 22 shows in detail the three significant positions throughout the full range of movement of these elements, as noted by the elements 37 and 56 and their phantom-lined versions 37B, 37C, 56B, and 56C. The elements 37 and 56 show the position corresponding to the full trim down position 11 of the actuator rod 5. The elements 37B and 56B show the position corresponding to the trim limit position 17 of the actuator rod 5, while the elements 37C and 56C show the position corresponding to the full extension 9 of the actuator rod 5.

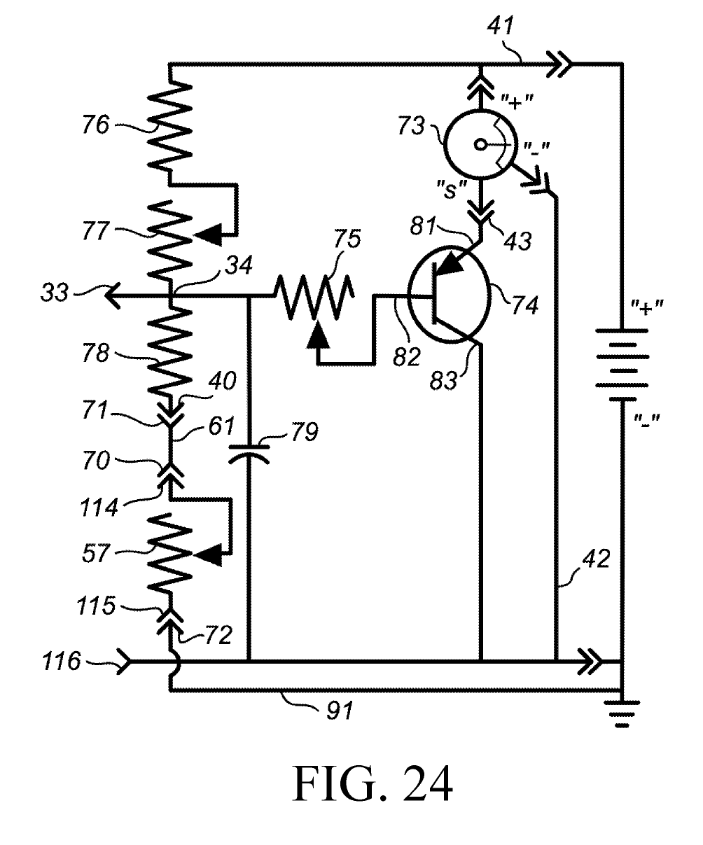

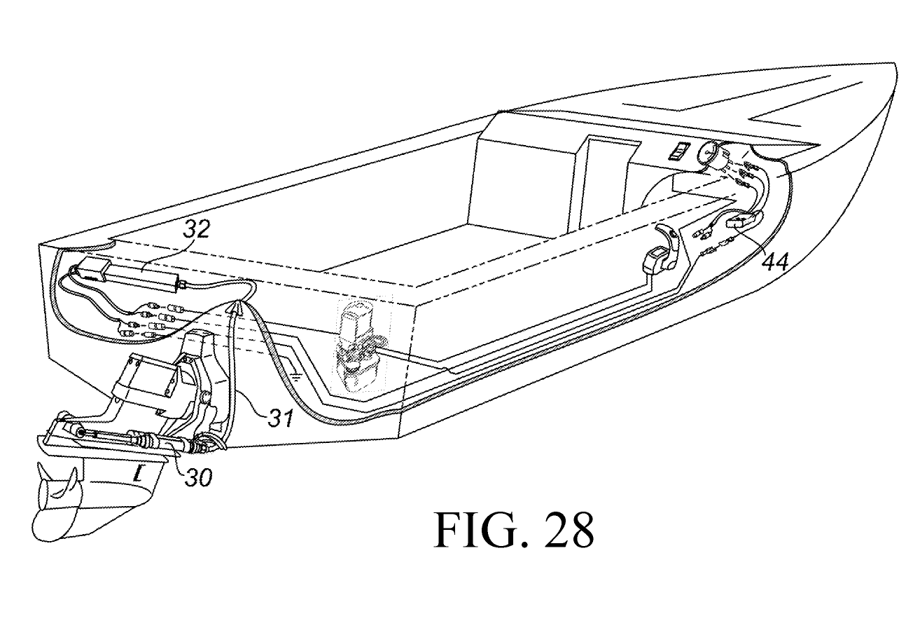

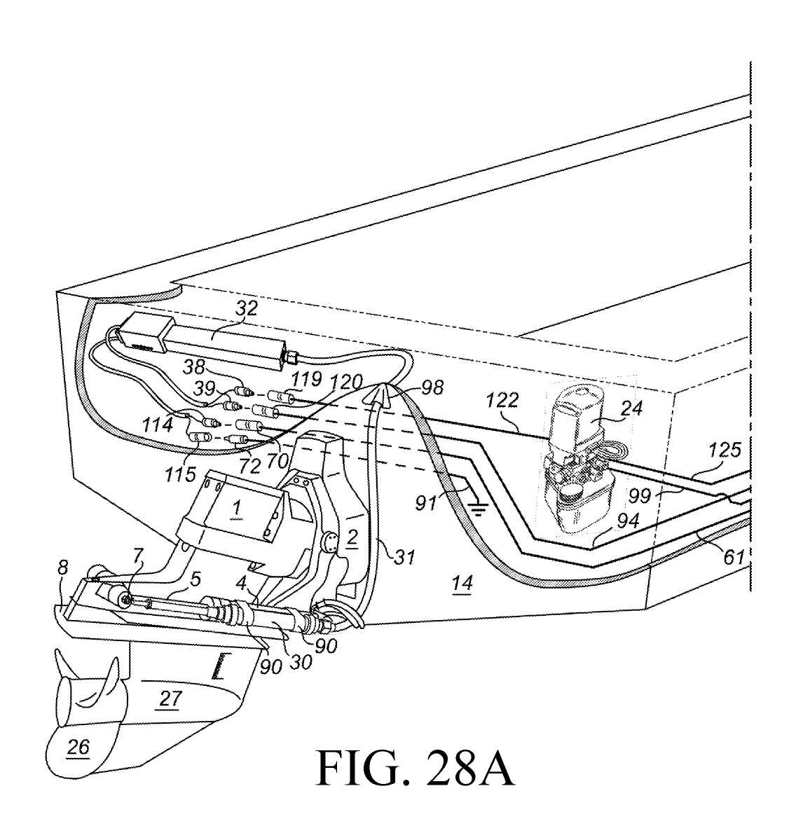

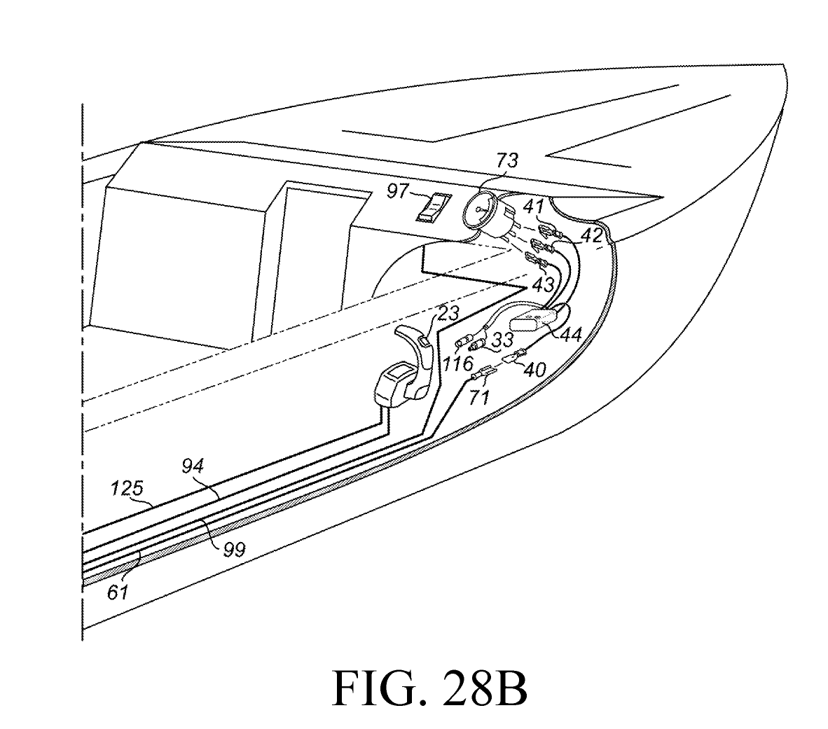

The resistance of the magnetic potentiometer 57 is at its lowest value while the wiper device 56 is at the low resistance endpoint 58 and increases to is maximum value when the wiper device 56 is at the high resistance endpoint 59 as referenced in FIG. 22. As the actuator rod 5 moves from the full down position 11 to the full up position 9, so does the potentiometer resistance increase from its minimum resistance to its maximum resistance, as measured in ohms. A primary advantage of the invention is that it can utilize prior art gauges and indicators for the helm display, results in their greater accuracy, and allows for adjustment of those devices. The resistance range that prior art trim sensor devices 95 operate within is approximately 10 ohms to 170 ohms. The magnetic potentiometer 57 of the invention replaces the function of the prior art trim sender 95. Yet, in order to allow some adjustment of the gauge or indicator readings, and to minimize the effects of any changes in the potentiometer's contact resistance over time, which is typical of a potentiometer, the magnetic potentiometer 57 needs to have a substantially higher resistance range than the prior art trim sender 95. Therefore, the resistance range of the magnetic potentiometer 57 within the electronic linear sensor 32 is not suitable to directly operate a prior art trim gauge or indicator. To achieve a compatible resistance range, the magnetic potentiometer 57 is connected by way of the duplex wire 69 and the associated vessel wiring 61 and 91 to the electronic interface module 44 that is located near the trim gauge 73 at the helm of the vessel. The electronic interface module 44 provides electrical compatibility of the magnetic potentiometer 57 to the trim gauge 73. Connectivity is achieved by the connectors 114 and 115 of the duplex wire 69, which connect to the connectors 70 and 72 of the vessel trim sender wiring 61 and 91, as shown in FIGS. 28A and 28B. As a means of installation of the invention, the trim sender wire 61 and its associated connector 71, that would normally lead to the sender connection on the trim gauge 73 in a prior art configuration (labeled “S” in FIG. 24), is disconnected from the gauge and instead connected to the sensor input wire 40 of the electronic interface module 44 as shown in FIG. 28B.

The electronic interface module 44, shown in FIGS. 23A and 23B, contains the circuitry and components needed to convert the higher resistance range of the magnetic potentiometer 57 to the lower resistance range expected by the trim gauge 73. The electronic schematic for the electronic interface module 44 is shown in FIG. 24. Power and electrical ground are supplied to the electronic interface module 44 by two wires that connect to the power 41 and ground 42 connections at the trim gauge 73, using piggy-back spade connectors, so that the trim gauge 73 and the electronic interface module 44 share the same electrical power 41 and ground 42 connections. The circuitry within the electronic interface module 44 contains a PNP transistor 74, two adjustable resistors 75 and 77, two fixed resistors 76 and 78, and a capacitor 79. The magnetic potentiometer 57 of the electronic linear sensor 32 completes the circuit by way of the duplex wiring 69 and the associated connectors 114 and 115 that connect to the vessel wiring 61 and 91 by way of the connectors 70 and 72.

The sender connector 43 of the electronic interface module 44 connects the sender tab (denoted by “S” in FIG. 24) of the prior art trim gauge 73 to the emitter side 81 of the PNP transistor 74. The collector side 83 of the PNP transistor 74 connects to electrical ground 42. There is a series of four resistors within the circuitry that spans from the power voltage 41 to electrical ground 42; two of fixed resistance 76 and 78, one of adjustable resistance 77, and the fourth is the magnetic potentiometer 57. A change in the resistance of the magnetic potentiometer 57, caused by movement of the outdrive 1 actuator rod 5, changes the overall resistance of the four-resistor series (76, 77, 78, and 57) and correspondingly the voltage at the reference point 34 on the base side 82 of the PNP transistor 74. The change in voltage at reference point 34 in the circuit governs the current flow from the emitter 81 to the base 82 of the PNP transistor 74 and results in a corresponding, as well as amplified, current flow from the emitter 81 to the collector 83 of the PNP transistor 74, which operates the trim gauge 73. The amplified current flow from the emitter 81 to the collector 83 of the PNP transistor 74 mimics the reduced resistance range expected by the trim gauge 73. The PNP transistor 74 has a regulating effect on the current flow through the trim gauge 73, because an increased current flow through the trim gauge 73 creates a higher voltage drop at the point where the trim gauge 73 connects to the emitter 81 of the PNP transistor 74, relative to the power supply voltage 41. Too much of a voltage drop through the trim gauge 73 will reduce the voltage at the emitter 81 of the PNP transistor 74 relative to the base 82 of the PNP transistor 74 to a point where it will be what is known to those experienced in the art of electronics as reversed biased, and will be unable to pass additional current. The dynamic regulation of the voltage at the base side 34 of the PNP transistor 74 that is ultimately governed by movement of the outdrive 1 actuator rod 5 causes the voltage at the emitter 81 of the PNP transistor 74 to follow the voltage at the base 82 of the transistor with a small amount of offset, known as the forward bias voltage, the emitter 81 voltage being the higher of the two voltages. A capacitor 79 is connected to the base side of the PNP transistor 74 at the reference point 34 to provide dampening to the circuit and avoid any tendency of the PNP transistor 74 to oscillate.

There is an adjustable resistor 75 within the electronic interface module 44 circuit that connects between the base 82 of the PNP transistor 74 and the reference point 34 as a means of adjusting the current amplification of the transistor. A second adjustable resistor 77, which is part of the four-resistor series (76, 77, 78, and 57), is used to adjust the range of voltage variation that will occur at the reference point 34 on the base side of the PNP transistor 74 as the potentiometer 57 resistance changes. The combination of the two adjustable resistors 75 and 77 in the circuit allows adjustment of the trim gauge 73 readings throughout the movement of the outdrive 1 actuator rod 5 for both the maximum and minimum readings as well as the sensitivity to outdrive 1 actuator rod 5 movements.

The junction among the two adjustable resistors 75 and 77, and the fixed resistor 78, provides a variable voltage point 34 based on the movement of the outdrive 1 actuator rod 5 that is also used as a voltage input to an analog to digital converter, which would enable a digital indication of the outdrive 1 position for display on an NMEA 2000 compatible device. An auxiliary wire with connector 33 is attached to the junction point 34 of the circuit for this purpose, as shown in the electronic schematic in FIG. 24.

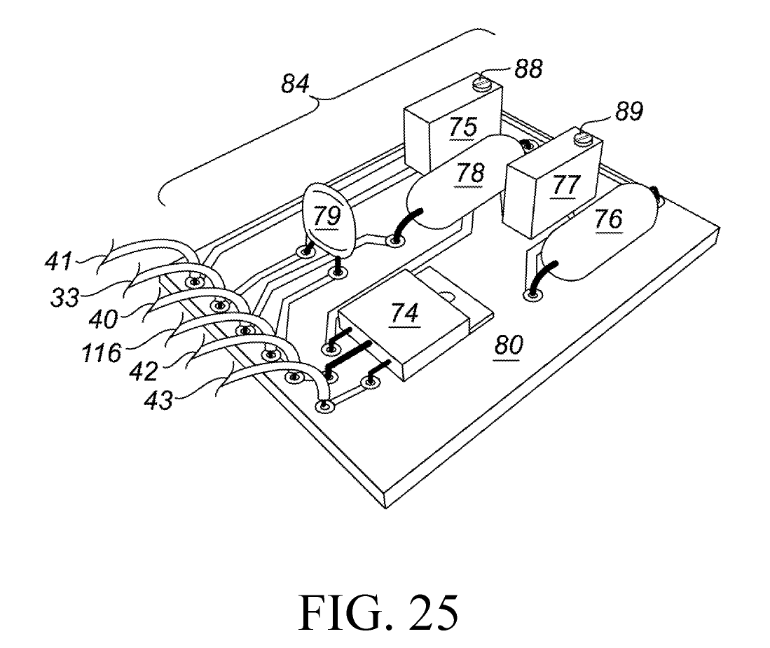

The electronic components of the electronic interface module 44 are connected into the circuit by way of the printed circuit board 80, and the circuit board assembly 84, shown in FIG. 25, is enclosed in a non-conductive case 85, as shown in FIG. 23B. There are two holes 86 and 87 in the case 85 that correspond to the two adjustment screw locations, 88 and 89, of the two adjustable resistors 75 and 77, where they reside in the case. The electronic components are coated with a plastic compound for protection against moisture related deterioration. The wire leads 33, 40, 41, 42, 43, and 116 that emerge from the interface module case 85 are of sufficient length to allow connection to the spade terminals on the rear face of the trim gauge 73 and the associated vessel wiring, while the module case 85 can be mounted to a nearby surface under the instrument panel at the helm of the vessel, as depicted in FIG. 28B. During the installation process of the invention, the range and sensitivity of the trim gauge 73 can be adjusted by turning the adjustment screws 88 and 89 on the associated adjustable resistors 75 and 77. Adjustment screw 89 on the adjustable resistor 77 provides adjustment to the voltage range at the base side 34 of the PNP transistor 74, controlling the minimum and maximum readings of the gauge. The adjustment screw 88 on the adjustable resistor 75 adjusts the current flow from the emitter 81 to the base 82 of the PNP transistor 74, which correspondingly adjusts the current flow between the emitter 81 and the collector 83 of the PNP transistor 74, controlling the sensitivity of the gauge 73.

Connectivity to an analog to digital signal converter for operating a digital display of the trim/tilt position relies solely on the voltage at reference point 34 and is achieved through the wires with connectors 33 and 116. The wire with connector 33, being the positive voltage and the wire with connector 116 is the electrical ground. Adjustment of the voltage range for digital signal conversion is achieved by the adjustment screw 89 on the adjustable resistor 77.

I claim:

1) A system to sense the position and movement of an actuator, having a reciprocating actuator rod, used to control the angular position relative to the operatively horizontal rotational axis of the outdrive unit of an inboard/outboard marine propulsion engine, that is comprised of
a mechanical position sensing device, having a barrel of any cross-sectional shape, with a reciprocating plunger, where the barrel is attached to the actuator and the axis of movement of the plunger is substantially parallel to the axis of movement of the actuator rod and the plunger is attached to the actuator rod, so that said rod equally transfers its movement to the plunger, which is attached to
a control cable that imparts the movement of the plunger to a wiper device that operates a potentiometer, and the distance of movement of the wiper device across the active operating range of the potentiometer conveyed by the control cable is substantially equal to the distance of movement originated by the actuator rod, and the potentiometer is connected to
an electronic interface module that provides multiple electronic outputs indicative of the position of the actuator rod to operate an electrical gauge, an electronic indicator, or an analog to digital signal converter.

2) The mechanical position sensing device of claim 1 alternatively being incorporated within the actuator body and actuator rod of claim 1, so that the mechanical position sensing device is an integral part of the actuator.

3) The plunger of claim 1 alternatively being combined into the control cable of claim 1 as a more rigid segment of said cable and that connects to the actuator rod of claim 1.

4) The potentiometer of claim 1 being of a physically linear type and having an operational length at least equal to the overall distance of movement capable by the actuator rod of claim 1.

5) The control cable of claim 1 being of push/pull type and having two ends, one end being affixed to the position sensing device of claim 1 and the other end being affixed to the potentiometer of claim 1, and the control cable transfers movement originating from the actuator rod of claim 1 to the potentiometer wiper device of claim 1 without mechanical reduction or alteration.

6) The electronic interface module of claim 1 that provides both electrical resistance and voltage outputs that are indicative of the position of the actuator rod of claim 1 as compared to its full range of movement, and having separate electrical connections that provide electrical resistance, current flow, and voltage ranges that are compatible with prior art gauges and indicators, and analog to digital conversion devices that enable digital display devices.

7) The ability to adjust the output and sensitivity of the electronic interface module of claim 1 to compensate for variations in the electrical properties of the potentiometer of claim 1 and the connected gauges, indicators and signal converters of claim 1, so that the intended output readings of these devices throughout the movement of the actuator rod of claim 1 are achieved.

8) An electrical switching function, combined with the potentiometer of claim 1, having an activation range that is a portion of the full distance of movement of the wiper device of claim 1, where the electrical switch is connected when the wiper device is within the activation range and disconnected when the wiper device is beyond the activation range, the activation range of the electrical switching function being manually adjustable, and both the electrical switching function and the potentiometer of claim 1 are operated by a magnetic field produced within the wiper device of claim 1.
